(19) United States
(12) Patent Application Publication
(10) Pub. No.: US 2015/0264597 A1
(43) Pub. Date: Sep. 17, 2015

(54) Communication Method, Base Station, and User Equipment

(71) Applicant: Huawei Technologies Co., Ltd., Shenzhen (CN)

(72) Inventors: Hongping Zhang, Shanghai (CN); Junhui Zhao, Shenzhen (CN); Qinghai Zeng, Shanghai (CN); Tao Zhong, Shenzhen (CN)

(21) Appl. No.: 14/726,128

(22) Filed: May 29, 2015

Related U.S. Application Data
(63) Continuation of application No. PCT/CN2012/085670, filed on Nov. 30, 2012.

(51) Int. Cl. H04W 28/02; H04W 24/10; H04W 28/08

(52) U.S. Cl. CPC H04W 28/0289; H04W 28/0231; H04W 28/085; H04W 24/10

(57) ABSTRACT

A communication method includes: receiving, by a user equipment, measurement configuration information sent by a base station, where the measurement configuration information is used to instruct the user equipment to perform measurement on a WiFi AP, and the measurement configuration information includes a WiFi measurement object and a WiFi measurement quantity; performing, by the user equipment, measurement on the WiFi measurement object according to the WiFi measurement quantity, to obtain a measurement report; and sending, by the user equipment, the measurement report to the base station, so that the base station determines, according to the measurement report, to offload the user equipment to the WiFi AP or stop communication between the user equipment and the WiFi AP.

This application is a continuation of International Application No. PCT/CN2012/085670, filed on Nov. 30, 2012, which is hereby incorporated by reference in its entirety.

### TECHNICAL FIELD

The present invention relates to the communications field, and in particular, to a communication method, a base station, and a user equipment.

### BACKGROUND

An LTE (Long Term Evolution) network is a current mobile communications network of the 3gpp (3^{rd} Generation Partnership Project) organization, and LTE is an evolved network of a UMTS (Universal Mobile Telecommunication System, Universal Mobile Telecommunications System). An air interface of LTE is implemented by deploying an eNB (evolved Node B, evolved Node B), where the eNB communicates with a UE (User Equipment, User Equipment) to implement transmission of a mobile service through the air interface.

WiFi (Wireless Fidelity) is a standard of a WLAN (Wireless Local Access Network), and is a communications network that consists of a wireless terminal and a WiFi AP (Access Point), where the AP may be referred to as a network bridge or an access point, and is a bridge between a conventional wired local area network and a wireless local access network. With the development of WiFi technologies, currently, a WiFi network can provide a convenient data service (for example, a WiFi network access service) for the UE.

As a quantity of users grows and data services increase, congestion often occurs in a mobile network. To relieve the congestion in the mobile network, a network operator needs to deploy more base stations to improve a network capacity, which inevitably causes an increase of an investment cost and a maintenance cost. To solve this problem, the network operator may use a manner of mobile data offloading, that is, connect a part of services (for example, a network access service) in the mobile network (for example, LTE) to a supplementary network (for example, WiFi (Wireless Fidelity) or a home NodeB), so as to relieve pressure on the mobile network.

However, how to implement offloading of a user equipment between a base station and a WIFI AP is a problem that needs to be solved currently.

### SUMMARY

The present invention provides a communication method, a base station, and a user equipment, which can implement offloading of a user equipment between a base station and a WIFI AP.

According to a first aspect, the present invention provides a communication method, including: receiving, by a user equipment, measurement configuration information sent by a base station, where the measurement configuration information is used to instruct the user equipment to perform measurement on a WiFi AP, and the measurement configuration information includes a WiFi measurement object and a WiFi measurement quantity; performing, by the user equipment, measurement on the WiFi measurement object according to the WiFi measurement quantity, to obtain a measurement report; and sending, by the user equipment, the measurement report to the base station, so that the base station determines, according to the measurement report, to offload the user equipment to the WiFi AP or stop communication between the user equipment and the WiFi AP.

In a first possible implementation manner of the first aspect, the receiving, by a user equipment, measurement configuration information sent by a base station specifically includes: receiving, by the user equipment, a radio resource control RRC connection release message sent by the base station, where the RRC connection release message includes the measurement configuration information; or receiving, by the user equipment, system information broadcast by the base station, where the system information includes the measurement configuration information; or receiving, by the user equipment, an RRC connection reconfiguration message sent by the base station, where the RRC connection reconfiguration message includes the measurement configuration information.

With reference to the first aspect or with reference to the first possible implementation manner, in a second possible implementation manner, the measurement configuration information further includes a measurement start indication, where the measurement start indication is used to indicate a time or a period for starting measurement on the WiFi measurement object.

With reference to the second possible implementation manner, in a third possible implementation manner, the performing, by the user equipment, measurement on the WiFi measurement object according to the WiFi measurement quantity specifically includes that: the measurement start indication is used to instruct the user equipment to perform, when the user equipment is in an idle state and after the user equipment receives a paging message sent by the base station, measurement on the WiFi measurement object according to the WiFi measurement quantity; or the measurement start indication is used to instruct the user equipment to perform, after the user equipment accesses the WiFi AP, measurement on the WiFi measurement object according to the WiFi measurement quantity; or the measurement start indication is used to instruct the user equipment to perform, after the user equipment accesses the base station, measurement on the WiFi measurement object according to the WiFi measurement quantity.

With reference to the first aspect or with reference to any one of the first to the third possible implementation manners, in a fourth possible implementation manner, the method further includes: sending, by the user equipment, capability information of the user equipment to the base station, so that the base station determines, according to the capability information of the user equipment, whether to send the measurement configuration information to the user equipment.

With reference to the first aspect or with reference to any one of the first to the fourth possible implementation manners, in a fifth possible implementation manner, the WiFi measurement object includes at least one of the following: a WiFi AP channel and a WiFi AP service set identifier SSID; and the WiFi measurement quantity includes at least one of the following: a received channel power indicator RCPI, a received signal to noise indicator RSNI, and a load situation of the WiFi AP.

According to a second aspect, the present invention provides a communication method, including: sending measurement configuration information to a user equipment, where the measurement configuration information is used to instruct the user equipment to perform measurement on a WiFi AP, and the measurement configuration information includes a WiFi measurement object and a WiFi measurement quantity, so that the user equipment performs measurement on the WiFi measurement object according to the WiFi measurement quantity; receiving a measurement report sent by the user equipment; and determining, according to the measurement report, to offload the user equipment to the WiFi AP or stop communication between the user equipment and the WiFi AP.

In a first possible implementation manner of the second aspect, the sending measurement configuration information to a user equipment includes sending a radio resource control RRC connection release message to the user equipment, where the RRC connection release message includes the measurement configuration information; or broadcasting system information to the user equipment, where the system information includes the measurement configuration information; or sending an RRC connection reconfiguration message to the user equipment, where the RRC connection reconfiguration message includes the measurement configuration information.

With reference to the second aspect or with reference to the first possible implementation manner, in a second possible implementation manner, the measurement configuration information further includes a measurement start indication, where the measurement start indication is used to indicate a time or a period for starting measurement by the user equipment on the WiFi measurement object.

According to a third aspect, the present invention provides a user equipment, including: a receiving unit, configured to receive measurement configuration information sent by a base station, where the measurement configuration information is used to instruct the user equipment to perform measurement on a WiFi AP, and the measurement configuration information includes a WiFi measurement object and a WiFi measurement quantity; a measuring unit, configured to perform measurement on the WiFi measurement object according to the WiFi measurement quantity, to obtain a measurement report; a sending unit, configured to send the measurement report to the base station, so that the base station determines, according to the measurement report, to offload the user equipment to the WiFi AP or stop communication between the user equipment and the WiFi AP.

In a first possible implementation manner of the third aspect, the receiving unit is specifically configured to receive a radio resource control RRC connection release message sent by the base station, where the RRC connection release message includes the measurement configuration information; or the receiving unit is specifically configured to receive system information broadcast by the base station, where the system information includes the measurement configuration information; or the receiving unit is specifically configured to receive an RRC connection reconfiguration message sent by the base station, where the RRC connection reconfiguration message includes the measurement configuration information.

With reference to the third aspect or with reference to the first possible implementation manner, in a second possible implementation manner, the measurement configuration information received by the receiving unit further includes a measurement start indication, where the measurement start indication is used to indicate a time or a period for starting measurement on the WiFi measurement object.

With reference to the second possible implementation manner, in a third possible implementation manner, the measuring unit is specifically configured to, the measurement start indication is used to instruct the user equipment to perform, when the user equipment is in an idle state and after the user equipment receives a paging message sent by the base station, measurement on the WiFi measurement object according to the WiFi measurement quantity; or the measuring unit is specifically configured to, the measurement start indication is used to instruct the user equipment to perform, after the user equipment accesses the WiFi AP, measurement on the WiFi measurement object according to the WiFi measurement quantity; or the measuring unit is configured to, the measurement start indication is used to instruct the user equipment to perform, after the user equipment accesses the base station, measurement on the WiFi measurement object according to the WiFi measurement quantity.

With reference to the third aspect or with reference to any one of the first to the third possible implementation manners, in a fourth possible implementation manner, the sending unit is further configured to send capability information of the user equipment to the base station, so that the base station determines, according to the capability information of the user equipment, whether to send the measurement configuration information to the user equipment.

According to a fourth aspect, the present invention provides a base station, including: a sending unit, configured to send measurement configuration information to a user equipment, where the measurement configuration information is used to instruct the user equipment to perform measurement on a WiFi AP, and the measurement configuration information includes a WiFi measurement object and a WiFi measurement quantity, so that the user equipment performs measurement on the WiFi measurement object according to the WiFi measurement quantity; a receiving unit, configured to receive the measurement report sent by the user equipment; and a control unit, configured to determine, according to the measurement report, to offload the user equipment to the WiFi AP or stop communication between the user equipment and the WiFi AP.

In a first possible implementation manner of the fourth aspect, the sending unit is specifically configured to send a radio resource control RRC connection release message to the user equipment, where the RRC connection release message includes the measurement configuration information; or the sending unit is specifically configured to broadcast system information to the user equipment, where the system information includes the measurement configuration information; or the sending unit is specifically configured to send an RRC connection reconfiguration message to the user equipment, where the RRC connection reconfiguration message includes the measurement configuration information.

With reference to the fourth aspect or with reference to the first possible implementation manner, in a second possible implementation manner, the measurement configuration information sent by the sending unit further includes a measurement start indication, where the measurement start indication is used to indicate a time or a period for starting measurement by the user equipment on the WiFi measurement object.

According to a fifth aspect, the present invention provides a user equipment, including a receiver, a processor, and a transmitter that are connected by using a bus, where the receiver is configured to receive measurement configuration information sent by a base station, where the measurement configuration information is used to instruct the user equipment to perform measurement on a WiFi AP, and the measurement configuration information includes a WiFi measurement object and a WiFi measurement quantity; the processor is configured to perform measurement on the WiFi measurement object according to the WiFi measurement quantity, to obtain a measurement report; and the transmitter is configured to send the measurement report to the base station, so that the base station determines, according to the measurement report, to offload the user equipment to the WiFi AP or stop communication between the user equipment and the WiFi AP.

In a first possible implementation manner of the fifth aspect, the receiver is specifically configured to receive a radio resource control RRC connection release message sent by the base station, where the RRC connection release message includes the measurement configuration information; or the receiver is specifically configured to receive system information broadcast by the base station, where the system information includes the measurement configuration information; or the receiver is specifically configured to receive an RRC connection reconfiguration message sent by the base station, where the RRC connection reconfiguration message includes the measurement configuration information.

With reference to the fifth aspect or with reference to the first possible implementation manner, in a second possible implementation manner, the measurement configuration information received by the receiver further includes a measurement start indication, where the measurement start indication is used to indicate a time or a period for starting measurement on the WiFi measurement object.

In a third possible implementation manner of the fifth aspect, the processor is specifically configured to, when the user equipment is in an idle state, perform measurement on the WiFi measurement object according to the WiFi measurement quantity and the measurement start indication that are in a paging message sent by the base station and received by the receiver; or the processor is specifically configured to, after the user equipment accesses the WiFi AP, perform measurement on the WiFi measurement object according to the WiFi measurement quantity and the measurement start indication; or the processor is specifically configured to, after the user equipment accesses the base station, perform measurement on the WiFi measurement object according to the WiFi measurement quantity and the measurement start indication.

With reference to the fifth aspect or with reference to any one of the first to the third possible implementation manners, in a fourth possible implementation manner, the transmitter is further configured to send capability information of the user equipment to the base station, so that the base station determines, according to the capability information of the user equipment, whether to send the measurement configuration information to the user equipment.

According to a sixth aspect, the present invention provides a base station, including a transmitter, a receiver, and a processor that are connected by using a bus, where the transmitter is configured to send measurement configuration information to a user equipment, where the measurement configuration information is used to instruct the user equipment to perform measurement on a WiFi AP, and the measurement configuration information includes a WiFi measurement object and a WiFi measurement quantity, so that the user equipment performs measurement on the WiFi measurement object according to the WiFi measurement quantity; the receiver is configured to receive a measurement report sent by the user equipment; and the processor is configured to determine, according to the measurement report, to offload the user equipment to the WiFi AP or stop communication between the user equipment and the WiFi AP.

In a first possible implementation manner of the sixth aspect, the transmitter is specifically configured to send a radio resource control RRC connection release message to the user equipment, where the RRC connection release message includes the measurement configuration information; or the transmitter is specifically configured to broadcast system information to the user equipment, where the system information includes the measurement configuration information; or the transmitter is specifically configured to send an RRC connection reconfiguration message to the user equipment, where the RRC connection reconfiguration message includes the measurement configuration information.

With reference to the sixth aspect or with reference to the first possible implementation manner, in a second possible implementation manner, the measurement configuration information further includes a measurement start indication, where the measurement start indication is used to indicate a time or a period for starting measurement by the user equipment on the WiFi measurement object.

Based on the foregoing solutions, according to the communication method, the base station, and the user equipment provided in the present invention, a WiFi measurement object and a WiFi measurement quantity that are sent by the base station are received, measurement is performed on the WiFi measurement object according to the WiFi measurement quantity to obtain a measurement report, and the measurement report is sent to the base station, so that the base station can determine, according to the measurement report, to offload a user equipment to a WiFi AP or stop communication between a user equipment and a WiFi AP, thereby implementing offloading of the user equipment between the base station and the WIFI AP.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a communication method according to an embodiment of the present invention;

FIG. 2 is a flowchart of a communication method according to another embodiment of the present invention;

FIG. 3 is a flowchart of a communication method according to still another embodiment of the present invention;

FIG. 4 is a flowchart of a communication method according to yet another embodiment of the present invention;

FIG. 5 is a flowchart of a communication method according to yet another embodiment of the present invention;

FIG. 6 is a flowchart of a communication method according to yet another embodiment of the present invention;

FIG. 7 is a flowchart of a communication method according to yet another embodiment of the present invention;

FIG. 8 is a schematic structural diagram of a user equipment according to an embodiment of the present invention;

FIG. 9 is a schematic structural diagram of a user equipment according to another embodiment of the present invention;

FIG. 10 is a schematic structural diagram of a base station according to an embodiment of the present invention;

FIG. 11 is a schematic structural diagram of a user equipment according to still another embodiment of the present invention;

FIG. 12 is a schematic structural diagram of a base station according to still another embodiment of the present invention; and

FIG. 13 is a schematic structural diagram of a communications system according to an embodiment of the present invention.

### DETAILED DESCRIPTION OF ILLUSTRATIVE EMBODIMENTS

To make the objectives, technical solutions, and advantages of the present invention clearer, the following describes the embodiments of the present invention in further detail with reference to the accompanying drawings.

Data offloading in the communications field may be understood as connecting a part of services (for example, an Internet access service) in a mobile communication system (for example, an LTE (Long Term Evolution) system) to a supplementary network (for example, a WiFi (Wireless Fidelity) or a home NodeB), so as to release pressures on the mobile communication system.

In embodiments of the present invention, a user equipment may perform, according to an instruction of a base station in a mobile communication system, WiFi measurement to obtain a measurement report, and send the measurement report to the base station, so that the base station may perform data offloading control on the user equipment according to the measurement report.

Various aspects are described in this specification with reference to a terminal and/or a base station.

A user equipment refers to a device that provides voice and/or data connectivity for a user, and includes a wireless terminal or a wired terminal. The wireless terminal may be a handheld device with a radio connection function, or another processing device connected to a radio modem, and may be a mobile terminal that communicates with one or more core networks by using a radio access network. For example, the wireless terminal may be a mobile phone (also referred to as a “cellular” phone) and a computer with a mobile terminal. For another example, the wireless terminal may also be a portable, pocket-sized, handheld, computer built-in, or in-vehicle mobile apparatus. For yet another example, the wireless terminal may be a mobile station (mobile station), an access point (access point), a user equipment (UE), or the like.

A base station may be a device that communicates with a wireless terminal over an air interface in an access network by using one or more cells. For example, the base station may be a base station (BTS) in the GSM or CDMA, may be a base station (NodeB) in the WCDMA, may be an evolved NodeB (eNB or e-NodeB) in the LTE, or may be a base station in an evolved network in future, which is not limited in the present invention.

Embodiments of the present invention may be applied to multiple communications systems, such as, a Long Term Evolution (LTE) system, a Wideband Code Division Multiple Access (WCDMA) system, and a general packet radio service.

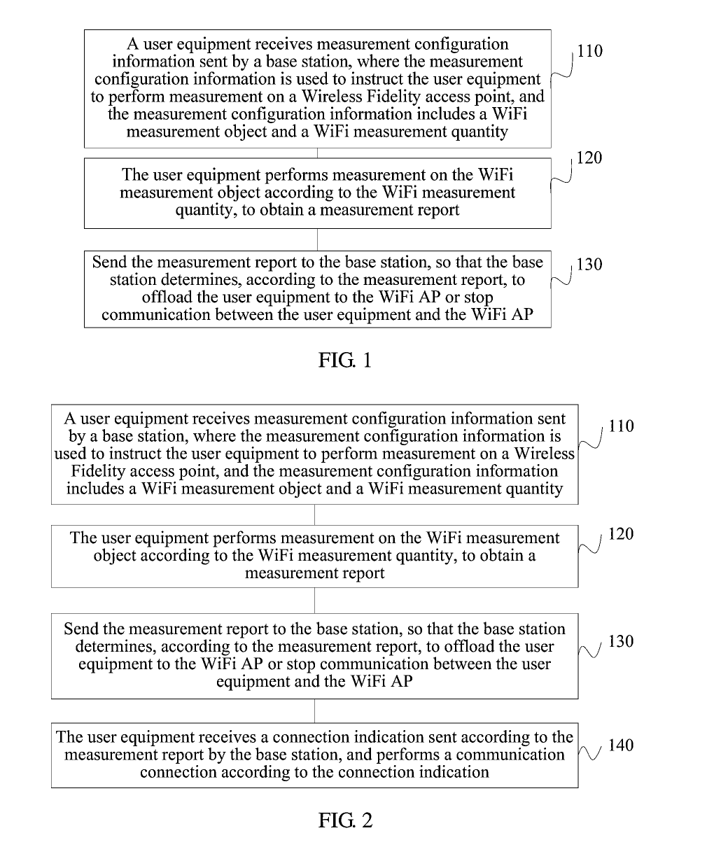

FIG. 1 is a flowchart of a communication method according to an embodiment of the present invention. Referring to FIG. 1, the communication method may include the following steps:

110. A user equipment receives measurement configuration information sent by a base station, where the measurement configuration information is used to instruct the user equipment to perform measurement on a Wireless Fidelity access point (WiFi AP), and the measurement configuration information includes a WiFi measurement object and a WiFi measurement quantity.

The WiFi measurement object and the WiFi measurement quantity may be determined according to a specific application scenario, where there may be one or more WiFi measurement objects and there may be one or more WiFi measurement quantities.

120. The user equipment performs measurement on the WiFi measurement object according to the WiFi measurement quantity, to obtain a measurement report.

130. Send the measurement report to the base station, so that the base station determines, according to the measurement report, to offload the user equipment to the WiFi AP or stop communication between the user equipment and the WiFi AP.

The foregoing measurement configuration information may be included in another message and sent by the base station, or may be sent separately by the base station, which is not limited in this embodiment of the present invention; and the foregoing measurement report may be included in another message and sent to the base station, or may be sent separately to the base station, which is not limited in this embodiment of the present invention. The user equipment mentioned in this embodiment of the present invention may be a device that has a communication function, such as, a mobile phone or a tablet computer.

According to the communication method provided in this embodiment of the present invention, a WiFi measurement object and a WiFi measurement quantity that are sent by a base station are received, measurement is performed on the WiFi measurement object according to the WiFi measurement quantity to obtain a measurement report, and the measurement report is sent to the base station, so that the base station can determine, according to the measurement report, to offload a user equipment to a WiFi AP or stop communication between a user equipment and a WiFi AP, thereby implementing offloading of the user equipment between the base station and the WIFI AP.

In this embodiment of the present invention, optionally, in the foregoing 110 step, when the user equipment receives the measurement configuration information sent by the base station, according to different application scenarios, the user equipment may receive a radio resource control (RRC) connection release message sent by the base station, where the RRC connection release message includes the measurement configuration information; the user equipment may receive system information broadcast by the base station, where the system information includes the measurement configuration information; or the user equipment may receive an RRC connection reconfiguration message sent by the base station, where the RRC connection reconfiguration message includes the measurement configuration information.

After receiving the measurement configuration information by using an RRC connection release message, the user equipment enters an idle state (which may be understood as that, for example, the user equipment is disconnected from the base station); after receiving the measurement configuration information by using an RRC connection reconfiguration message, the user equipment keeps in a connected state (which may be understood as that, for example, communication between the user equipment and the base station is continuous); when receiving the measurement configuration information by means of cell broadcast, the user equipment is usually in the idle state.

In this embodiment of the present invention, optionally, the measurement configuration information may further include a measurement start indication, where the measurement start indication is used to indicate a time or a period for starting measurement on the WiFi measurement object. In the foregoing 120 step, when measurement is performed on the WiFi measurement object according to the WiFi measurement quantity, the measurement may be performed on the WiFi measurement object according to the WiFi measurement quantity and according to the time or the period indicated by the measurement start indication.

Further, the measurement start indication is used to instruct the user equipment to perform, when the user equipment is in the idle state and after the user equipment receives a paging message sent by the base station, measurement on the WiFi measurement object according to the WiFi measurement quantity.

For example, the user equipment enters the idle state after receiving the RRC connection release message, where the base station carries the measurement configuration information in the RRC connection release message. For another example, the user equipment is originally in the idle state, and acquires the measurement configuration information by means of broadcast of the base station. When the base station initiates a service by using a paging message, the user equipment may initiate a connection to the base station and immediately perform related measurement on the WiFi AP. This solution can shorten time for initiating the related measurement on the WiFi AP and can reduce a delay of offloading the user equipment to the WiFi AP, thereby improving user experience.

Further, the measurement start indication is used to instruct the user equipment to perform, after the user equipment accesses the WiFi AP, measurement on the WiFi measurement object according to the WiFi measurement quantity.

For example, the user equipment has been offloaded to the WiFi AP, and the user equipment performs measurement according to the time or the period indicated by the measurement start indication, so as to learn the WiFi measurement quantity, for example, to learn a situation of a WiFi signal strength RCPI. Optionally, the user equipment may initiate measurement for 5 times in 200 ms. This solution can detect whether the WIFI AP is still applicable to the offloading of the user equipment; and if the WIFI AP is not applicable to the offloading of the user equipment, the user equipment is handed over back to the base station, and communication is performed by the base station to ensure communication quality.

Further, the measurement start indication is used to instruct the user equipment to perform, after the user equipment accesses the base station, measurement on the WiFi measurement object according to the WiFi measurement quantity.

For another example, if the measurement start indication is used to instruct the user equipment to immediately perform measurement, the user equipment immediately performs measurement on the WiFi measurement object according to the WiFi measurement quantity.

For another example, if the measurement start indication is used to instruct the user equipment to perform measurement at a specific time, when the specific time arrives, the user equipment performs measurement on the WiFi measurement object according to the WiFi measurement quantity.

For another example, if the measurement start indication is used to instruct to perform measurement in a specific period, when the specific period arrives, the user equipment performs measurement on the WiFi measurement object according to the WiFi measurement quantity.

For another example, if the measurement start indication is used to instruct to perform measurement after a trigger message sent by the base station is received, after the user equipment receives the trigger message, the user equipment performs measurement on the WiFi measurement object according to the WiFi measurement quantity.

It should be understood that, this embodiment of the present invention further includes another case in which the user equipment performs measurement on the WiFi measurement object according to the measurement start indication and the WiFi measurement quantity, and details are no longer described herein.

Certainly, in this embodiment of the present invention, a time of sending the measurement report may further be preset, and the measurement configuration information no longer includes a sending indication. For example, the user equipment immediately sends a measurement report to the base station after the measurement report is generated; and in this case, if the user equipment does not access the base station, the user equipment first accesses the base station; or the user equipment sends the measurement report next time the user equipment accesses the base station.

In this embodiment of the present invention, optionally, the measurement configuration information may further include a measurement report indication and a threshold that corresponds to the WiFi measurement quantity, where the measurement report indication is used to indicate a condition for generating the measurement report. In the foregoing 120 step, the measurement report may be generated according to the measurement report indication and the threshold that corresponds to the WiFi measurement quantity.

Specifically, if the measurement configuration information further includes a first threshold corresponding to a first WiFi measurement quantity in the WiFi measurement quantity, the measurement report may be generated according to the measurement report indication when a measurement result of the first WiFi measurement quantity is greater than the first threshold. For example, the first WiFi measurement quantity may be an RCPI and the first threshold that is configured may be 25 dBm; then the measurement report is triggered according to the measurement report indication when an RCPI obtained by means of measurement by a terminal is greater than 25 dBm.

Alternatively, if the measurement configuration information further includes a second threshold corresponding to a second WiFi measurement quantity in the WiFi measurement quantity, the measurement report is generated according to the measurement report indication when a measurement result of the second WiFi measurement quantity is less than the second threshold. For example, the second WiFi measurement quantity may be an RCPI and the second threshold that is configured may be 15 dBm; then the measurement report is triggered according to the measurement report indication when an RCPI obtained by means of measurement by a terminal is less than 15 dBm.

Alternatively, if the measurement configuration information further includes a third threshold corresponding to a third WiFi measurement quantity in the WiFi measurement quantity, and includes a fourth threshold corresponding to a fourth WiFi measurement quantity in the WiFi measurement quantity, the measurement report may be generated according to the measurement report indication when a measurement result of the third WiFi measurement quantity is greater than the third threshold and a measurement result of the fourth WiFi measurement quantity is less than the fourth threshold; or the measurement report may be generated according to the measurement report indication when a measurement result of the third WiFi measurement quantity is less than the third threshold and a measurement result of the fourth WiFi measurement quantity is greater than the fourth threshold; or the measurement report may be generated according to the measurement report indication when a measurement result of the third WiFi measurement quantity is greater than the third threshold and a measurement result of the fourth WiFi measurement quantity is greater than the fourth threshold; or the measurement report may be generated according to the measurement report indication when a measurement result of the third WiFi measurement quantity is less than the third threshold and a measurement result of the fourth WiFi measurement quantity is less than the fourth threshold. For example, the third WiFi measurement quantity may be an RCPI and the third threshold that is configured may be 25 dBm, and the fourth WiFi measurement quantity may be an RSNI and the fourth threshold that is configured may be −10 dBm; then the measurement report is triggered according to the measurement report indication when an RCPI obtained by means of measurement by a terminal is greater than 25 dBm and an RSNI obtained by means of measurement by the terminal is less than −10 dBm; or the measurement report is triggered according to the measurement report indication when an RCPI obtained by means of measurement by a terminal is less than 25 dBm and an RSNI obtained by means of measurement by the terminal is greater than −10 dBm; or the measurement report is triggered according to the measurement report indication when an RCPI obtained by means of measurement by a terminal is greater than 25 dBm and an RSNI obtained by means of measurement by the terminal is greater than −10 dBm; or the measurement report is triggered according to the measurement report indication when an RCPI obtained by means of measurement by a terminal is less than 25 dBm and an RSNI obtained by means of measurement by the terminal is less than −10 dBm.

The foregoing first WiFi measurement quantity, second WiFi measurement quantity, third WiFi measurement quantity, and fourth WiFi measurement quantity are exemplary, which should not be considered as a limitation on this embodiment of the present invention. For example, the first WiFi measurement quantity may also be the RSNI or a WiFi channel load situation, the second WiFi measurement quantity may also be the RSNI or a WiFi channel load situation, the third WiFi measurement quantity may also be the RSNI or a WiFi channel load situation, and the fourth WiFi measurement quantity may also be the RCPI or a WiFi channel load situation.

It should be understood that, an item included in the WiFi measurement object and an item included in the WiFi measurement quantity in this embodiment of the present invention are merely used as an example for description, the WiFi measurement object and the WiFi measurement quantity in this embodiment of the present invention may further include other items that are not listed, that is, the item included in the WiFi measurement object and the item included in the WiFi measurement quantity are not limited in this embodiment of the present invention.

In this embodiment of the present invention, optionally, the user equipment sends capability information of the user equipment to the base station, so that the base station determines, according to the capability information of the user equipment, whether to send the measurement configuration information to the user equipment.

For example, the capability information may include information about whether the user equipment supports WiFi and information about which channel (frequency channel number) is supported. After determining that the user equipment has a WiFi function, the base station determines content of the measurement configuration message according to WiFi capability information of the user equipment.

In this embodiment of the present invention, optionally, the WiFi measurement object includes at least one of the following: a WiFi AP channel and a WiFi AP service set identifier SSID (SSID). The WiFi measurement quantity may include at least one of the following: a received channel power indicator (RSNI), a received signal to noise indicator RSNI, and a load situation of the WiFi AP. The RCPI is used to reflect signal strength of a WiFi channel, the RSNI is used to reflect an interference situation of the WiFi channel, and WiFi channel load is used to reflect a load or busy/idle situation of WiFi; when there are multiple WiFi measurement quantities, thresholds corresponding to the WiFi measurement quantities include a threshold that corresponds to each WiFi measurement quantity; and the measurement report indication is used to indicate a condition for generating a measurement report by the user equipment, and the measurement report indication may be identified in a specific data field of the measurement configuration information.

In this embodiment of the present invention, optionally, the measurement configuration information may further include a sending indication, where the sending indication is used to indicate a time of sending the measurement report. In the foregoing 130 step, when the user equipment sends the measurement report to the base station, the user equipment may send the measurement report to the base station according to the time indicated by the sending indication.

For example, if the sending indication is used to instruct to immediately send the measurement report, the user equipment immediately sends the measurement report to the base station.

Alternatively, if the sending indication is used to instruct to send the measurement report when the user equipment accesses the base station, the user equipment sends the measurement report when accessing the base station.

In this embodiment of the present invention, optionally, when the user equipment immediately sends the measurement report to the base station, if the user equipment is in the idle state, the user equipment immediately accesses the base station, and sends the measurement report to the base station after accessing the base station.

In this embodiment of the present invention, optionally, as shown in FIG. 2, after sending the measurement report to the base station in the foregoing 130 step, the method may further include the following step:

140. The user equipment receives a connection indication sent according to the measurement report by the base station, and performs a communication connection according to the connection indication.

For example, the user equipment may access or be disconnected from the WiFi AP according to the connection indication.

In this way, the base station sends the connection indication according to the sent measurement report, which can ensure communication quality and improve user experience.

According to the communication method provided in this embodiment of the present invention, a WiFi measurement object and a WiFi measurement quantity that are sent by a base station are received, measurement is performed on the WiFi measurement object according to the WiFi measurement quantity to obtain a measurement report, and the measurement report is sent to the base station, so that the base station can determine, according to the measurement report, to offload a user equipment to a WiFi AP or stop communication between a user equipment and a WiFi AP, thereby implementing offloading of the user equipment between the base station and the WIFI AP.

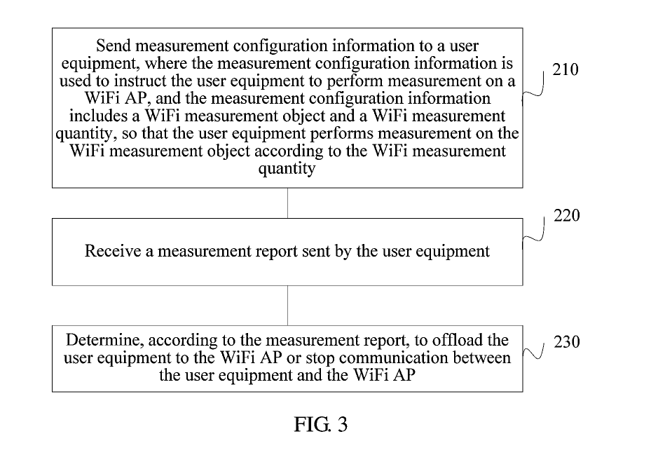

FIG. 3 is a flowchart of another communication method according to an embodiment of the present invention. Referring to FIG. 3, the communication method may include the following steps:

210. Send measurement configuration information to a user equipment, where the measurement configuration information is used to instruct the user equipment to perform measurement on a WiFi AP, and the measurement configuration information includes a WiFi measurement object and a WiFi measurement quantity, so that the user equipment performs measurement on the WiFi measurement object according to the WiFi measurement quantity.

220. Receive a measurement report sent by the user equipment.

230. Determine, according to the measurement report, to offload the user equipment to the WiFi AP or stop communication between the user equipment and the WiFi AP.

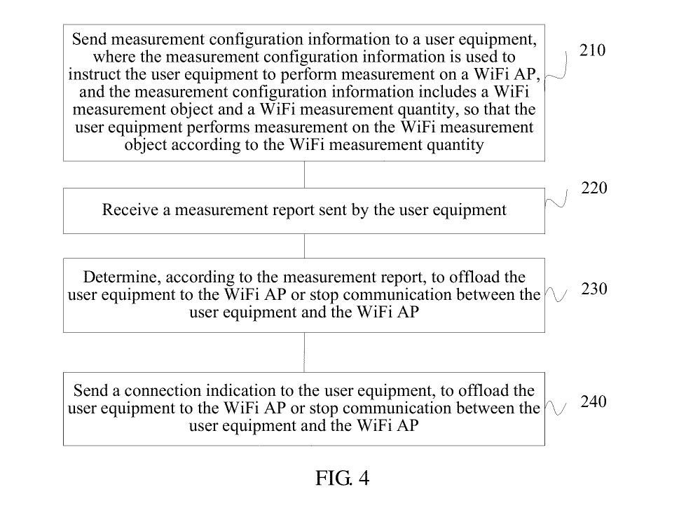

In this embodiment of the present invention, optionally, as shown in FIG. 4, after the foregoing 230 step, the method may further include the following step:

240. Send a connection indication to the user equipment, to offload the user equipment to the WiFi AP or stop communication between the user equipment and the WiFi AP.

In this embodiment of the present invention, optionally, when the measurement configuration information is sent to the user equipment in the foregoing 210 step, a radio resource control RRC connection release message may be sent to the user equipment, where the RRC connection release message includes the measurement configuration information; or system information may be broadcast to the user equipment, where the system information includes the measurement configuration information; or an RRC connection reconfiguration message may be sent to the user equipment, where the RRC connection reconfiguration message includes the measurement configuration information.

In this way, the measurement configuration information may be sent to the user equipment in multiple manners, so as to adapt to different application scenarios.

In this embodiment of the present invention, optionally, the measurement configuration information further includes a measurement start indication, where the measurement start indication is used to indicate a time or a period for starting measurement by the user equipment on the WiFi measurement object.

In this way, WiFi measurement control may be performed on the user equipment.

For a detailed description of this embodiment of the present invention, reference may be made to a relevant part in the foregoing 110 to 140 steps.

According to the communication method provided in this embodiment of the present invention, measurement configuration information that includes a WiFi measurement object and a WiFi measurement quantity is sent to a user equipment, so that the user equipment performs measurement on the WiFi measurement object according to the WiFi measurement quantity; a measurement report obtained after the user equipment performs measurement is received, so that it can be determined, according to the measurement report, to offload the user equipment to a WiFi AP or stop communication between the user equipment and a WiFi AP, thereby implementing offloading of the user equipment between a base station and the WiFi AP.

In the following, that a base station sends, in an LTE system by means of RRC (Radio Resource Control), an RRC connection release message that includes measurement configuration information to a user equipment is used as an example to describe the foregoing method embodiment in detail.

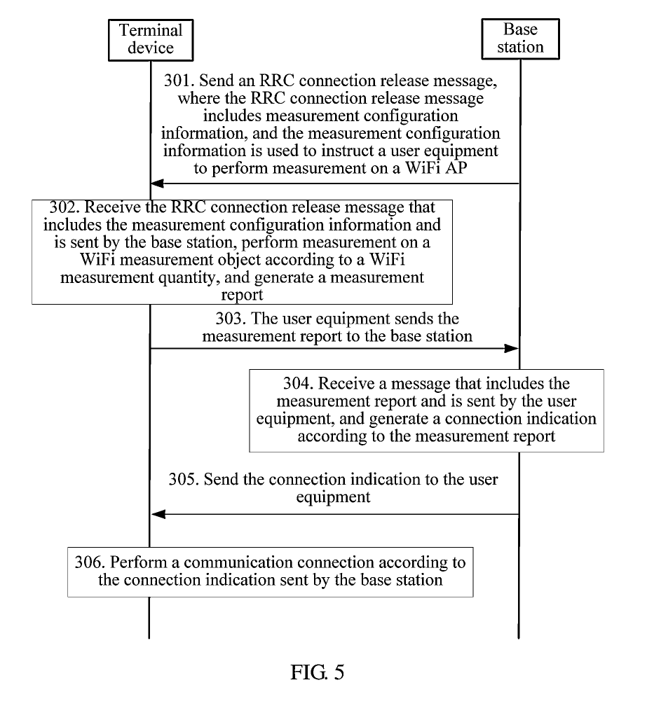

Referring to FIG. 5, the method may include the following steps:

301. The base station sends an RRC connection release message to the user equipment, where the RRC connection release message includes measurement configuration information, and the measurement configuration information is used to instruct the user equipment to perform measurement on a WiFi AP.

Optionally, the measurement configuration information includes at least one of the following: a WiFi measurement object, a WiFi measurement quantity, a threshold that corresponds to the WiFi measurement quantity, and a measurement report indication.

In this embodiment of the present invention, optionally, before the base station sends the RRC connection release message to the user equipment, the base station may acquire WiFi capability information of the user equipment, for example, information about whether the user equipment supports WiFi and information about which channel (frequency channel number) is supported. After determining that the user equipment has a WiFi function, the base station determines content of the measurement configuration message according to the WiFi capability information of the user equipment. Certainly, if the base station has already learned the WiFi capability information of the user equipment, the base station may no longer acquire the WiFi capability information of the user equipment.

302. The user equipment receives the RRC connection release message that includes the measurement configuration information and is sent by the base station, performs measurement on the WiFi measurement object according to the WiFi measurement quantity, and generates a measurement report.

In this embodiment of the present invention, optionally, the user equipment may start, according to a time indicated by a measurement start indication, measurement that is performed according to the WiFi measurement quantity on the WiFi measurement object, where the measurement start indication may be included in the measurement configuration information and sent by the base station.

For example, the measurement start indication is used to instruct the user equipment to perform, when the user equipment is in an idle state and after the user equipment receives a paging message sent by the base station, measurement on the WiFi measurement object according to the WiFi measurement quantity.

For another example, the measurement start indication is used to instruct the user equipment to perform, after the user equipment accesses the WiFi AP, measurement on the WiFi measurement object according to the WiFi measurement quantity.

For another example, the measurement start indication is used to instruct the user equipment to perform, after the user equipment accesses the base station, measurement on the WiFi measurement object according to the WiFi measurement quantity.

Certainly, the base station and the user equipment may agree that, the measurement configuration information does not include measurement starting time indicated by the measurement start indication. For example, the user equipment immediately starts measurement when receiving the measurement configuration information, or the user equipment starts measurement when accessing the WiFi AP, or the user equipment starts measurement after receiving the paging message, or the user equipment starts measurement after the base station initiates an RRC connection.

In this embodiment of the present invention, the user equipment enters the idle state (disconnected from the base station) after receiving the RRC connection release message.

In addition, when measurement is performed in 302 step, the measurement may be performed in a state in which the user equipment accesses the WiFi AP, or may be performed in a state in which the user equipment does not access the WiFi AP.

303. The user equipment sends the measurement report to the base station.

In this embodiment of the present invention, the measurement configuration information may not include a sending indication. When the measurement configuration information does not include a sending indication, the base station and the user equipment may agree on a time of sending the measurement report. For example, the user equipment immediately sends the measurement report to the base station after generating the measurement report; and in this case, if the user equipment does not access the base station, the user equipment first initiates access to the base station; or, the user equipment sends the measurement report when accessing the base station.

In this embodiment of the present invention, optionally, after 303 step, the method may further include the following steps:

304. The base station receives a message that includes the measurement report and is sent by the user equipment, and generates a connection indication according to the measurement report.

For example, when the measurement report shows that a WiFi AP with a relatively strong signal (for example, signal strength is higher than a preset threshold) exists in an environment in which the user equipment is located, an instruction for accessing the WiFi AP with the relatively strong signal may be generated.

For another example, when the measurement report shows that multiple WiFi APs with a relatively strong signal (for example, signal strength is higher than a preset threshold) exist in an environment in which the user equipment is located, an instruction for accessing a WiFi AP with a strongest signal among the multiple WiFi APs with the relatively strong signal may be generated.

For another example, when the measurement report shows that a signal of a WiFi AP currently connected to the user equipment is relatively weak (for example, signal strength is lower than a preset threshold), an instruction for being disconnected from the currently connected WiFi AP and using a mobile communications system (for example, LTE) to perform data transmission may be generated, so as to ensure data transmission quality.

For another example, when the measurement report shows that a WiFi AP with a relatively strong signal (for example, signal strength is higher than a preset threshold) exists in an environment in which the user equipment is located, an instruction for being disconnected from a mobile communications system (for example, LTE) that currently performs data transmission and connecting to the WiFi AP with the relatively strong signal may be generated, so as to reduce a data transmission amount of the mobile communications system.

For another example, when the measurement report shows that a signal of a WiFi AP currently connected to the user equipment is relatively weak (for example, signal strength is lower than a preset threshold) and that a WiFi AP with a relatively strong signal (for example, signal strength is higher than a preset threshold) exists, an instruction for being handed over from the currently connected WiFi AP to the WiFi AP with the relatively strong signal may be generated, so as to ensure data transmission quality.

In this way, the base station sends the connection indication according to the measurement report sent by the user equipment, so that the user equipment performs a communication connection according to the connection indication, which can ensure communication quality of the user equipment and improve user experience.

305. The base station sends the connection indication to the user equipment.

Specifically, the connection indication may be sent separately, or the connection indication may be carried in another message for sending.

306. The user equipment performs a communication connection according to the connection indication sent by the base station.

Specifically, a corresponding connection operation is performed according to content of the connection indication in the foregoing 304 step.

In this way, the base station generates the connection indication according to the measurement report sent by the user equipment; therefore, the user equipment performs a communication connection according to the connection indication, which can ensure communication quality.

It should be noted that, in another embodiment of the present invention, in the foregoing 301 step, the base station may also send, by means of RRC, a connection reconfiguration message that includes the measurement configuration information to the user equipment. Correspondingly, in the foregoing 302 step, the user equipment receives the RRC connection reconfiguration message that includes the measurement configuration information and is sent by the base station.

According to the communication method provided in this embodiment of the present invention, a WiFi measurement object and a WiFi measurement quantity that are sent by a base station are received, measurement is performed on the WiFi measurement object according to the WiFi measurement quantity to obtain a measurement report, and the measurement report is sent to the base station, so that the base station can determine, according to the measurement report, to offload a user equipment to a WiFi AP or stop communication between a user equipment and a WiFi AP, thereby implementing offloading of the user equipment between the base station and the WIFI AP.

A difference from the embodiment corresponding to FIG. 5 lies in that, in another embodiment of the present invention, a message that includes measurement configuration information may be sent to a user equipment by means of cell broadcast. Correspondingly, the user equipment receives, by means of cell broadcast, the message that includes the measurement configuration information and is sent by a base station.

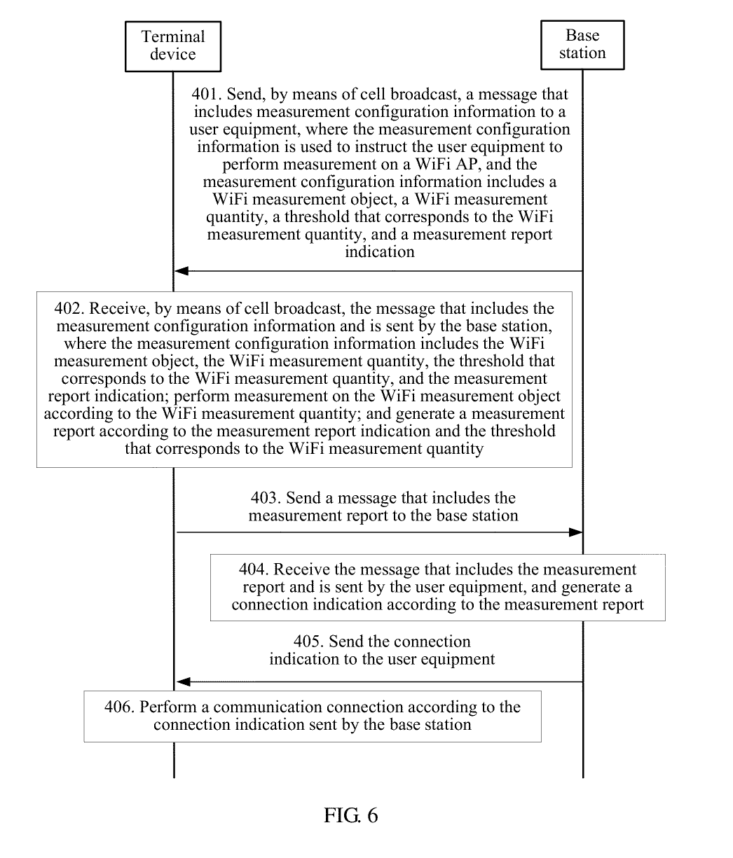

Specific steps are shown in FIG. 6 and may include the following:

401. The base station sends, by means of cell broadcast, a message that includes measurement configuration information to the user equipment, where the measurement configuration information is used to instruct the user equipment to perform measurement on a WiFi AP.

402. The user equipment receives, by means of cell broadcast, the message that includes the measurement configuration information and is sent by the base station.

Optionally, the measurement configuration information includes at least one of the following: a WiFi measurement object, a WiFi measurement quantity, a threshold that corresponds to the WiFi measurement quantity, and a measurement report indication. For example, the user equipment performs measurement on the WiFi measurement object according to the WiFi measurement quantity, and generates a measurement report according to the measurement report indication and the threshold that corresponds to the WiFi measurement quantity.

403. The user equipment sends a message that includes the measurement report to the base station.

In this embodiment of the present invention, optionally, after 403 step, the method may further include the following steps:

404. The base station receives the message that includes the measurement report and is sent by the user equipment, and generates a connection indication according to the measurement report.

405. The base station sends the connection indication to the user equipment.

406. The user equipment performs a communication connection according to the connection indication sent by the base station.

In this way, the base station generates the connection indication according to the measurement report sent by the user equipment; therefore, the user equipment performs a communication connection according to the connection indication, which can ensure communication quality.

The foregoing 401 to 406 steps are described briefly. For detailed content, reference is made to a corresponding part in the foregoing 301 to 306 steps.

According to the communication method provided in this embodiment of the present invention, a WiFi measurement object and a WiFi measurement quantity that are sent by a base station are received, measurement is performed on the WiFi measurement object according to the WiFi measurement quantity to obtain a measurement report, and the measurement report is sent to the base station, so that the base station can determine, according to the measurement report, to offload a user equipment to a WiFi AP or stop communication between a user equipment and a WiFi AP, thereby implementing offloading of the user equipment between the base station and the WIFI AP.

A difference from the embodiment corresponding to FIG. 5 lies in that, in yet another embodiment of the present invention, a message that includes measurement configuration information may be sent by using an RRC connection reconfiguration message. Correspondingly, a user equipment receives the RRC connection reconfiguration message that includes the measurement configuration information and is sent by a base station.

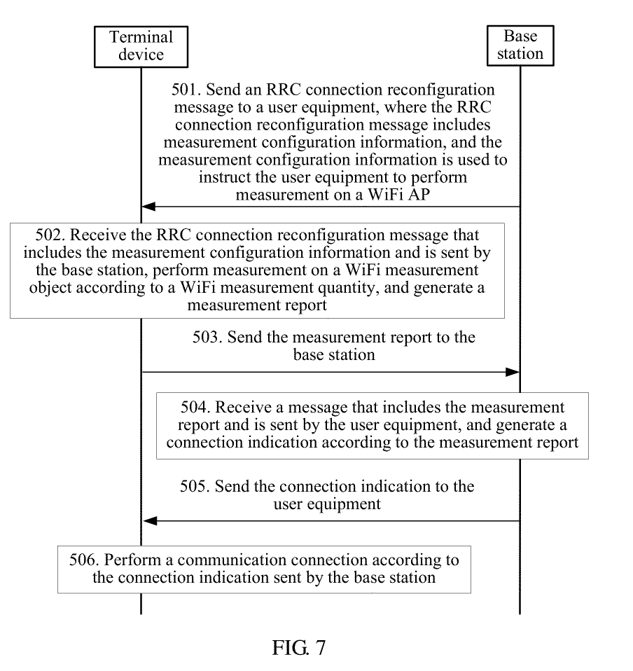

Specific steps are shown in FIG. 7 and include the following:

501. The base station sends an RRC connection reconfiguration message to the user equipment, where the RRC connection reconfiguration message includes measurement configuration information, and the measurement configuration information is used to instruct the user equipment to perform measurement on a WiFi AP.

In the foregoing 301 step, the user equipment enters an idle state (disconnected from the base station) after receiving the measurement configuration information by using the RRC connection release message; herein, the user equipment keeps in a connected state (continuously connected to the base station) after receiving the measurement configuration information by using the RRC connection reconfiguration message.

502. The user equipment receives the RRC connection reconfiguration message that includes the measurement configuration information and is sent by the base station, performs measurement on a WiFi measurement object according to a WiFi measurement quantity, and generates a measurement report.

In addition, when measurement is performed in 502 step, the measurement may be performed in a state in which the user equipment accesses the WiFi AP, or may be performed in a state in which the user equipment does not access the WiFi AP.

503. The user equipment sends the measurement report to the base station.

In this embodiment of the present invention, optionally, after 503 step, the method may further include the following steps:

504. The base station receives a message that includes the measurement report and is sent by the user equipment, and generates a connection indication according to the measurement report.

505. The base station sends the connection indication to the user equipment.

Specifically, the connection indication may be sent separately, or the connection indication may be carried in another message for sending.

506. The user equipment performs a communication connection according to the connection indication sent by the base station.

Specifically, a corresponding connection operation is performed according to content of the connection indication in the foregoing 504 and 505 steps.

In this way, the base station generates the connection indication according to the measurement report sent by the user equipment; therefore, the user equipment performs a communication connection according to the connection indication, which can ensure communication quality.

The foregoing 501 to 506 steps are described briefly. For detailed content, reference is made to a corresponding part in the foregoing 301 to 306 steps.

According to the communication method provided in this embodiment of the present invention, a WiFi measurement object and a WiFi measurement quantity that are sent by a base station are received, measurement is performed on the WiFi measurement object according to the WiFi measurement quantity to obtain a measurement report, and the measurement report is sent to the base station, so that the base station can determine, according to the measurement report, to offload a user equipment to a WiFi AP or stop communication between a user equipment and a WiFi AP, thereby implementing offloading of the user equipment between the base station and the WIFI AP.

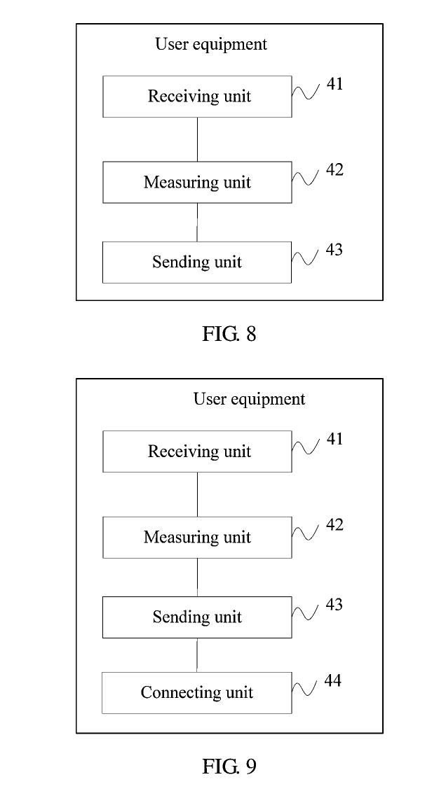

As shown in FIG. 8, an embodiment of the present invention provides a user equipment, including: a receiving unit 41, a measuring unit 41, and a sending unit 43.

The receiving unit 41 is configured to receive measurement configuration information sent by a base station, where the measurement configuration information is used to instruct the user equipment to perform measurement on a WiFi AP, and the measurement configuration information includes a WiFi measurement object and a WiFi measurement quantity.

After receiving the measurement configuration information by using an RRC connection release message, the user equipment enters an idle state (which may be understood as that, for example, the user equipment is disconnected from the base station); after receiving the measurement configuration information by using an RRC connection reconfiguration message, the user equipment keeps in a connected state (which may be understood as that, for example, communication between the user equipment and the base station is continuous); when receiving the measurement configuration information by means of cell broadcast, the user equipment is usually in the idle state.

The measuring unit 42 is configured to perform measurement on the WiFi measurement object according to the WiFi measurement quantity, to obtain a measurement report.

The sending unit 43 is configured to send the measurement report to the base station, so that the base station determines, according to the measurement report, to offload the user equipment to the WiFi AP or stop communication between the user equipment and the WiFi AP.

In this embodiment of the present invention, optionally, as shown in FIG. 9, the user equipment may further include a connecting unit 44, configured to receive a connection indication sent according to the measurement report by the base station, and perform a communication connection according to the connection indication.

In this way, the base station generates the connection indication according to the measurement report sent by the user equipment; therefore, the user equipment performs a communication connection according to the connection indication, which can ensure communication quality.

In this embodiment of the present invention, optionally, the receiving unit 41 is specifically configured to receive system information broadcast by the base station, where the system information includes the measurement configuration information; or the receiving unit 41 is specifically configured to receive an RRC connection reconfiguration message sent by the base station, where the RRC connection reconfiguration message includes the measurement configuration information.

In this embodiment of the present invention, optionally, the measurement configuration information received by the receiving unit 41 further includes a measurement start indication, where the measurement start indication is used to indicate a time or a period for starting measurement on the WiFi measurement object.

Further, optionally, the measuring unit 42 is specifically configured to, the measurement start indication is used to instruct the user equipment to perform, when the user equipment is in the idle state and after the receiving unit 41 receives a paging message sent by the base station, measurement on the WiFi measurement object according to the WiFi measurement quantity; the measuring unit 41 is specifically configured to, the measurement start indication is used to instruct the user equipment to perform, after the user equipment accesses the WiFi AP, measurement on the WiFi measurement object according to the WiFi measurement quantity; or the measuring unit 41 is specifically configured to, the measurement start indication is used to instruct the user equipment to perform, after the user equipment accesses the base station, measurement on the WiFi measurement object according to the WiFi measurement quantity.

In this embodiment of the present invention, optionally, the sending unit 43 is further configured to send capability information of the user equipment to the base station, so that the base station determines, according to the capability information of the user equipment, whether to send the measurement configuration information to the user equipment.

In this embodiment of the present invention, optionally, the WiFi measurement object may include a WiFi AP channel, or the WiFi measurement object may include a WiFi AP service set identifier SSID, or the WiFi measurement object may include a WiFi AP channel and a WiFi AP SSID; in addition, the WiFi measurement quantity may include at least one of the following: a received channel power indicator RCPI, a received signal to noise indicator RSNI, and a load situation of the WiFi AP. The RCPI is used to reflect signal strength of a WiFi channel, the RSNI is used to reflect an interference situation of the WiFi channel, and WiFi channel load is used to reflect a load or busy/idle situation of WiFi; when there are multiple WiFi measurement quantities, thresholds corresponding to the WiFi measurement quantities include a threshold that corresponds to each WiFi measurement quantity; and the measurement report indication is used to indicate a condition for generating a measurement report by the user equipment, and the measurement report indication may be identified in a specific data field of the measurement configuration information.

The user equipment in this embodiment of the present invention can perform an action of the user equipment in the foregoing method embodiments. The user equipment receives a WiFi measurement object and a WiFi measurement quantity that are sent by a base station, performs measurement on the WiFi measurement object according to the WiFi measurement quantity to obtain a measurement report, and then sends the measurement report to the base station, so that the base station can determine, according to the measurement report, to offload the user equipment to a WiFi AP or stop communication between the user equipment and a WiFi AP, thereby implementing offloading of the user equipment between the base station and the WIFI AP.

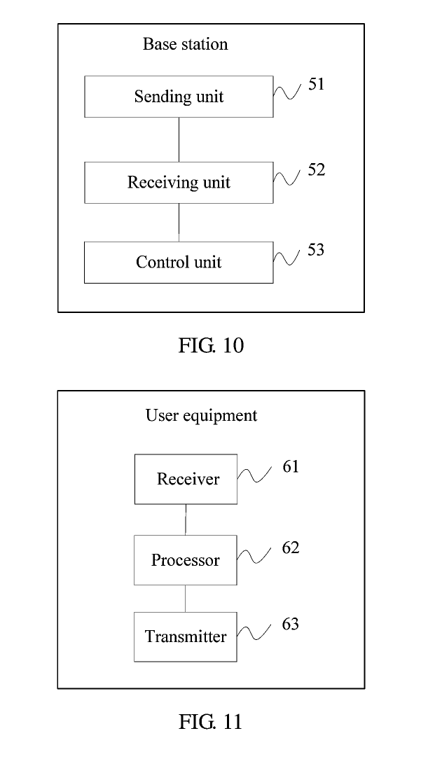

As shown in FIG. 10, an embodiment of the present invention provides a base station, including: a sending unit 51, a receiving unit 52, and a control unit 53, where the sending unit 51 is configured to send measurement configuration information to a user equipment, where the measurement configuration information is used to instruct the user equipment to perform measurement on a WiFi AP, and the measurement configuration information includes a WiFi measurement object and a WiFi measurement quantity, so that the user equipment performs measurement on the WiFi measurement object according to the WiFi measurement quantity; the receiving unit 52 is configured to receive a measurement report sent by the user equipment; and the control unit 53 is configured to determine, according to the measurement report, to offload the user equipment to the WiFi AP or stop communication between the user equipment the WiFi AP.

In this embodiment of the present invention, optionally, the sending unit 51 is specifically configured to send a radio resource control RRC connection release message to the user equipment, where the RRC connection release message includes the measurement configuration information; the sending unit 51 is specifically configured to broadcast system information to the user equipment, where the system information includes the measurement configuration information; or the sending unit 51 is specifically configured to send an RRC connection reconfiguration message to the user equipment, where the RRC connection reconfiguration message includes the measurement configuration information.

In this embodiment of the present invention, optionally, the measurement configuration information sent by the sending unit 51 further includes a measurement start indication, where the measurement start indication is used to indicate a time or a period for starting measurement by the user equipment on the WiFi measurement object.

In this embodiment of the present invention, optionally, a connection indication is sent to the user equipment and is used to offload the user equipment to the WiFi AP or stop communication between the user equipment and the WiFi AP.

The base station provided in this embodiment of the present invention can perform an action of the base station in the foregoing method embodiments. The base station sends measurement configuration information that includes a WiFi measurement object and a WiFi measurement quantity to a user equipment, so that the user equipment performs measurement on the WiFi measurement object according to the WiFi measurement quantity; and the base station receives a measurement report obtained after the user equipment performs measurement, so that the base station can determine, according to the measurement report, to offload the user equipment to a WiFi AP or stop communication between the user equipment and a WiFi AP, thereby implementing offloading of the user equipment between the base station and the WIFI AP.

An embodiment of the present invention provides another user equipment, as shown in FIG. 11, including: a receiver 61, a processor 62, and a transmitter 63, where the receiver 61 is configured to receive measurement configuration information sent by a base station, where the measurement configuration information is used to instruct the user equipment to perform measurement on a WiFi AP, and the measurement configuration information includes a WiFi measurement object and a WiFi measurement quantity; where the processor 62 is configured to perform measurement on the WiFi measurement object according to the WiFi measurement quantity, to obtain a measurement report; and where the transmitter 63 is configured to send the measurement report to the base station, so that the base station determines, according to the measurement report, to offload the user equipment to the WiFi AP or stop communication between the user equipment and the WiFi AP.

In this embodiment of the present invention, optionally, the WiFi measurement object may include a WiFi channel (frequency channel number), or may include a WiFi SSID, or may include a WiFi channel and a WiFi SSID; and the WiFi measurement quantity may include at least one of the following: an RCPI, an RSNI, and a load situation of a WiFi channel. The RCPI is used to reflect signal strength of a WiFi channel, the RSNI is used to reflect an interference situation of the WiFi channel, and WiFi channel load is used to reflect a load or busy/idle situation of WiFi.

In this embodiment of the present invention, optionally, the receiver 61 is specifically configured to receive a radio resource control RRC connection release message sent by the base station, where the RRC connection release message includes the measurement configuration information; or the receiver 61 is specifically configured to receive system information broadcast by the base station, where the system information includes the measurement configuration information; the receiver 61 is specifically configured to receive an RRC connection reconfiguration message sent by the base station, where the RRC connection reconfiguration message includes the measurement configuration information.

In this embodiment of the present invention, optionally, the measurement configuration information received by the receiver 61 further includes a measurement start indication, where the measurement start indication is used to indicate a time or a period for starting measurement on the WiFi measurement object.

In this embodiment of the present invention, optionally, the processor 62 is specifically configured to, when the user equipment is in an idle state, perform measurement on the WiFi measurement object according to the WiFi measurement quantity and the measurement start indication that are in a paging message sent by the base station and received by the receiver; the processor 62 is specifically configured to, after the user equipment accesses the WiFi AP, perform measurement on the WiFi measurement object according to the WiFi measurement quantity and the measurement start indication; or the processor 62 is specifically configured to, after the user equipment accesses the base station, perform measurement on the WiFi measurement object according to the WiFi measurement quantity and the measurement start indication.

In this embodiment of the present invention, optionally, the transmitter 63 is further configured to send capability information of the user equipment to the base station, so that the base station determines, according to the capability information of the user equipment, whether to send the measurement configuration information to the user equipment.

The user equipment provided in this embodiment of the present invention receives a WiFi measurement object and a WiFi measurement quantity that are sent by a base station, performs measurement on the WiFi measurement object according to the WiFi measurement quantity to obtain a measurement report, and sends the measurement report to the base station, so that the base station can determine, according to the measurement report, to offload the user equipment to a WiFi AP or stop communication between the user equipment and a WiFi AP, thereby implementing offloading of the user equipment between the base station and the WIFI AP.

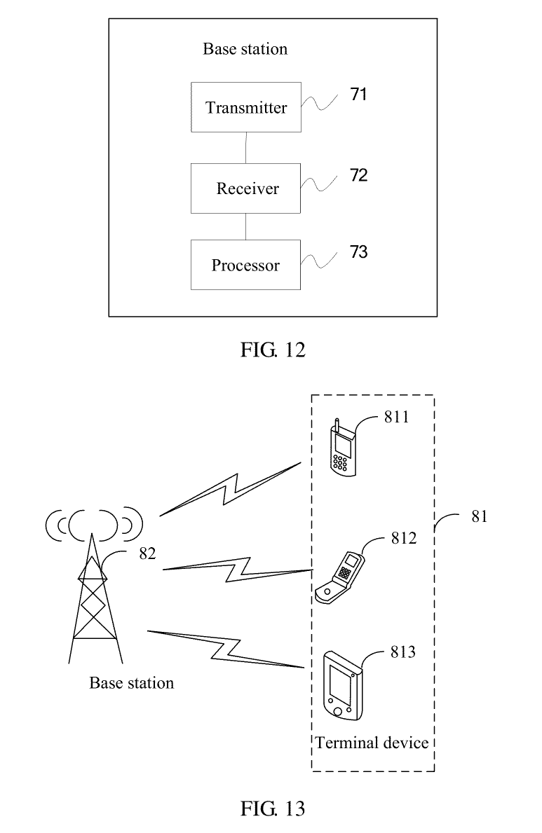

An embodiment of the present invention provides another user equipment, as shown in FIG. 12, including: a transmitter 71, a receiver 72, and a processor 73, where the transmitter 71 is configured to send measurement configuration information to a base station, where the measurement configuration information is used to instruct the user equipment to perform measurement on a WiFi AP, and the measurement configuration information includes a WiFi measurement object and a WiFi measurement quantity, so that the user equipment performs measurement on the WiFi measurement object according to the WiFi measurement quantity; where the receiver 72 is configured to receive a measurement report sent by the user equipment; and where the processor 73 is configured to determine, according to the measurement report, to offload the user equipment to the WiFi AP or stop communication between the user equipment and the WiFi AP.

In this embodiment of the present invention, optionally, the transmitter 71 is specifically configured to send a radio resource control RRC connection release message to the user equipment, where the RRC connection release message includes the measurement configuration information; the transmitter 71 is specifically configured to broadcast system information to the user equipment, where the system information includes the measurement configuration information; or the transmitter 71 is specifically configured to send an RRC connection reconfiguration message to the user equipment, where the RRC connection reconfiguration message includes the measurement configuration information.

In this embodiment of the present invention, optionally, the measurement configuration information further includes a measurement start indication, where the measurement start indication is used to indicate a time or a period for starting measurement by the user equipment on the WiFi measurement object.

The base station provided in this embodiment of the present invention sends measurement configuration information that includes a WiFi measurement object and a WiFi measurement quantity to a user equipment, so that the user equipment performs measurement on the WiFi measurement object according to the WiFi measurement quantity; and the base station receives a measurement report obtained after the user equipment performs measurement, so that the base station can determine, according to the measurement report, to offload the user equipment to a WiFi AP or stop communication between the user equipment and a WiFi AP, thereby implementing offloading of the user equipment between the base station and the WIFI AP.

As shown in FIG. 13, an embodiment of the present invention provides a communications system, including: a user equipment 81 and a base station 82; where the user equipment 81 is configured to receive measurement configuration information sent by the base station 82, where the measurement configuration information is used to instruct the user equipment to perform measurement on a WiFi AP, and the measurement configuration information includes a WiFi measurement object and a WiFi measurement quantity; the user equipment 81 performs measurement on the WiFi measurement object according to the WiFi measurement quantity to obtain a measurement report; and the user equipment 81 sends the measurement report to the base station 82, so that the base station 82 determines, according to the measurement report, to offload the user equipment 81 to the WiFi AP or stop communication between the user equipment 81 and the WiFi AP; and where the base station 82 is configured to: send the measurement configuration information to the user equipment 81, where the measurement configuration information is used to instruct the user equipment 81 to perform measurement on the WiFi AP, and the measurement configuration information includes the WiFi measurement object and the WiFi measurement quantity, so that the user equipment 81 performs measurement on the WiFi measurement object according to the WiFi measurement quantity; receive the measurement report sent by the user equipment 81; and determine, according to the measurement report, to offload the user equipment 81 to the WiFi AP or stop communication between the user equipment 81 and the WiFi AP.

Optionally, the base station 82 is further configured to send, according to the measurement report, a connection indication to the user equipment 81, so that the user equipment 81 performs a communication connection according to the connection indication.

Optionally, the user equipment 81 is further configured to receive the connection indication sent according to the measurement report by the base station 82, and perform a communication connection according to the connection indication.

In this way, the base station generates the connection indication according to the measurement report sent by the user equipment, and the user equipment performs a communication connection according to the connection indication, which can ensure communication quality.

In this embodiment of the present invention, optionally, the WiFi measurement object may include a WiFi channel (frequency channel number), or may include a WiFi SSID, or may include a WiFi channel and a WiFi SSID; and the WiFi measurement quantity may include at least one of the following: an RCPI, an RSNI, and a load situation of a WiFi channel. The RCPI is used to reflect signal strength of a WiFi channel, the RSNI is used to reflect an interference situation of the WiFi channel, and WiFi channel load is used to reflect a load or busy/idle situation of WiFi.

The user equipment 81 in this embodiment of the present invention may be 811, 812, or 813 shown in FIG. 13. It should be understood that the user equipment 81 may also be another device that has a communication function, which is not limited in this embodiment of the present invention. Units included in the user equipment 81 and specific functions of the units are the same as those of a user equipment provided in another embodiment of the present invention; units included in the base station 82 and specific functions of the units are the same as those of a base station provided in another embodiment of the present invention.

According to the communications system provided in this embodiment of the present invention, a user equipment receives measurement configuration information that includes a WiFi measurement object and a WiFi measurement quantity and is sent by a base station, performs measurement on the WiFi measurement object according to the WiFi measurement quantity to obtain a measurement report, and sends the measurement report to the base station, so that the base station can determine, according to the measurement report, to offload the user equipment to a WiFi AP or stop communication between the user equipment and a WiFi AP, thereby implementing offloading of the user equipment between the base station and the WIFI AP.

Embodiments of the present invention are mainly applied when a user equipment is offloaded between a base station and a WiFi AP. In the embodiments of the present invention, a base station in a mobile communications system (for example, an LTE system) sends measurement configuration information to a user equipment, triggers the user equipment to perform measurement on a WiFi AP, and learns WiFi AP information of an environment in which the user equipment is located, so as to control an operation such as access to the WiFi AP by the user equipment or disconnection from the WiFi AP by the user equipment, thereby implementing offloading of the user equipment between the base station and the WIFI AP.

It should be noted that: When a data sending apparatus and a data receiving apparatus that are provided in the foregoing embodiments are described, the foregoing division of functional modules is used merely as an example for description; in an actual application, the functions may be allocated, according to requirements, to different functional modules to implement, that is, an internal structure of the device is divided into different functional modules, so as to implement all or a part of functions described above. In addition, the apparatus and the corresponding method that are provided in the foregoing embodiments pertain to a same concept. For a specific implementation process, reference is made to the method embodiments, and details are not described herein again.

A person of ordinary skill in the art may understand that all or a part of the steps of the foregoing embodiments may be implemented by hardware or a program instructing related hardware. The program may be stored in a computer-readable storage medium. The foregoing storage medium may include: a read-only memory, a magnetic disk, or an optical disc.

The embodiments in this specification are all described in a progressive manner, for same or similar parts in the embodiments, reference may be made to these embodiments, and each embodiment focuses on a difference from other embodiments. Especially, an apparatus embodiment is basically similar to a method embodiment, and therefore is described briefly; for relevant parts, reference is made to descriptions in the method embodiment part. The described apparatus embodiment is merely exemplary. The units described as separate parts may or may not be physically separate, and parts displayed as units may or may not be physical units, may be located in one position, or may be distributed on multiple network units. A part or all of the modules may be selected according to actual needs to achieve the objectives of the solutions of the embodiments. A person of ordinary skill in the art may understand and implement the embodiments of the present invention without creative efforts.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that such implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in the form of a software product. The software product is stored in a storage medium, and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM,), a random access memory (RAM,), a magnetic disk, or an optical disc.

According to the description of the foregoing embodiments, a person skilled in the art may clearly understand that the present invention may be implemented by using software plus necessary universal hardware, where the universal hardware includes an integrated circuit, a universal CPU, a universal memory, a universal element, and the like; and certainly may also be implemented by using dedicated hardware such as a dedicated integrated circuit, a dedicated CPU, a dedicated memory, and a dedicated element; but in many cases, the former is a preferred implementation manner. Based on such an understanding, the technical solutions of the present invention essentially or the part contributing to the prior art may be implemented in the form of a software product. The software product is stored in a readable storage medium, such as a floppy disk, a hard disk or an optical disc of a computer, and includes several instructions for instructing a computer device (which may be a personal computer, a server, or a network device) to perform the methods described in the embodiments of the present invention.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A communication method comprising:
receiving, by a user equipment, measurement configuration information sent by a base station, wherein the measurement configuration information is used to instruct the user equipment to perform a measurement on a Wireless Fidelity access point (WiFi AP), and wherein the measurement configuration information comprises a WiFi measurement object and a WiFi measurement quantity;
performing, by the user equipment, a measurement on the WiFi measurement object according to the WiFi measurement quantity thereby obtaining a measurement report; and
sending, by the user equipment, the measurement report to the base station, so that the base station determines, according to the measurement report, to offload the user equipment to the WiFi AP or to stop communication between the user equipment and the WiFi AP.

2. The method according to claim 1, wherein receiving, by the user equipment, the measurement configuration information comprises:
receiving, by the user equipment, a radio resource control RRC connection release message sent by the base station, wherein the RRC connection release message comprises the measurement configuration information;
receiving, by the user equipment, system information broadcast by the base station, wherein the system information comprises the measurement configuration information; or
receiving, by the user equipment, an RRC connection reconfiguration message sent by the base station, wherein the RRC connection reconfiguration message comprises the measurement configuration information.

3. The method according to claim 1, wherein the measurement configuration information further comprises a measurement start indication, wherein the measurement start indication is used to indicate a time or a period for staring the measurement on the WiFi measurement object.

4. The method according to claim 3, wherein performing, by the user equipment, the measurement on the WiFi measurement object according to the WiFi measurement quantity comprises:
using the measurement start indication to instruct the user equipment to perform, when the user equipment is in an idle state and after the user equipment receives a paging message sent by the base station, the measurement on the WiFi measurement object according to the WiFi measurement quantity;
using the measurement start indication to instruct the user equipment to perform, after the user equipment accesses the WiFi AP, the measurement on the WiFi measurement object according to the WiFi measurement quantity; or
using the measurement start indication to instruct the user equipment to perform, after the user equipment accesses the base station, the measurement on the WiFi measurement object according to the WiFi measurement quantity.

5. The method according to claim 1, further comprising sending, by the user equipment, capability information of the user equipment to the base station, so that the base station determines, according to the capability information of the user equipment, whether to send the measurement configuration information to the user equipment.

6. The method according to claim 1, wherein the WiFi measurement object comprises at least one of the following a WiFi AP channel and a WiFi AP service set identifier SSID, and wherein the WiFi measurement quantity comprises at least one of the following a received channel power indicator RCPI, a received signal to noise indicator RSNI, and a load situation of the WiFi AP.

7. A communication method comprising:
sending measurement configuration information to a user equipment, wherein the measurement configuration information is used to instruct the user equipment to perform a measurement on a Wireless Fidelity access point (WiFi AP), wherein the measurement configuration information comprises a WiFi measurement object and a WiFi measurement quantity, and wherein the user equipment performs a measurement on the WiFi measurement object according to the WiFi measurement quantity;
receiving a measurement report sent by the user equipment; and
determining, according to the measurement report, to offload the user equipment to the WiFi AP or to stop communication between the user equipment and the WiFi AP.

8. The method according to claim 7, wherein sending the measurement configuration information to the user equipment comprises:
sending a radio resource control RRC connection release message to the user equipment, wherein the RRC connection release message comprises the measurement configuration information;
broadcasting system information to the user equipment, wherein the system information comprises the measurement configuration information; or
sending an RRC connection reconfiguration message to the user equipment, wherein the RRC connection reconfiguration message comprises the measurement configuration information.

9. The method according to claim 7, wherein the measurement configuration information further comprises a measurement start indication, wherein the measurement start indication is used to indicate a time or a period for staring the measurement by the user equipment on the WiFi measurement object.

10. A user equipment comprising:
a receiver configured to receive measurement configuration information sent by a base station, wherein the measurement configuration information is used to instruct a user equipment to perform a measurement on a Wireless Fidelity access point (WiFi AP), and wherein the measurement configuration information comprises a WiFi measurement object and a WiFi measurement quantity;
a processor configured to perform a measurement on the WiFi measurement object according to the WiFi measurement quantity and to obtain a measurement report; and
a transmitter configured to send the measurement report to the base station so that the base station determines, according to the measurement report, to offload the user equipment to the WiFi AP or to stop communication between the user equipment and the WiFi AP.

11. The user equipment according to claim 10, wherein:
the receiver is configured to receive a radio resource control RRC connection release message sent by the base station, wherein the RRC connection release message comprises the measurement configuration information;
the receiver is configured to receive system information broadcast by the base station, wherein the system information comprises the measurement configuration information; or
the receiver is configured to receive an RRC connection reconfiguration message sent by the base station, wherein the RRC connection reconfiguration message comprises the measurement configuration information.

12. The user equipment according to claim 10, wherein the measurement configuration information received by the receiver further comprises a measurement start indication, wherein the measurement start indication is used to indicate a time or a period for starting the measurement on the WiFi measurement object.

13. The user equipment according to claim 10, wherein:
the processor is configured to, when the user equipment is in an idle state, perform the measurement on the WiFi measurement object according to the WiFi measurement quantity and a measurement start indication that are in a paging message sent by the base station and received by the receiver;
the processor is configured to, after the user equipment accesses the WiFi AP, perform the measurement on the WiFi measurement object according to the WiFi measurement quantity and the measurement start indication; or
the processor is configured to, after the user equipment accesses the base station, perform the measurement on the WiFi measurement object according to the WiFi measurement quantity and the measurement start indication.

14. The user equipment according to claim 10, wherein the transmitter is further configured to send capability information of the user equipment to the base station, so that the base station determines, according to the capability information of the user equipment, whether to send the measurement configuration information to the user equipment.

15. A base station comprising:
a transmitter configured to send measurement configuration information to a user equipment, wherein the measurement configuration information is used to instruct the user equipment to perform a measurement on a Wireless Fidelity access point (WiFi AP), wherein the measurement configuration information comprises a WiFi measurement object and a WiFi measurement quantity, and wherein the user equipment performs a measurement on the WiFi measurement object according to the WiFi measurement quantity;
a receiver configured to receive a measurement report sent by the user equipment; and
a processor configured to determine, according to the measurement report, to offload the user equipment to the WiFi AP or to stop communication between the user equipment and the WiFi AP.

16. The base station according to claim 15, wherein:
the transmitter is configured to send a radio resource control RRC connection release message to the user equipment, wherein the RRC connection release message comprises the measurement configuration information;
the transmitter is configured to broadcast system information to the user equipment, wherein the system information comprises the measurement configuration information; or
the transmitter is configured to send an RRC connection reconfiguration message to the user equipment, wherein the RRC connection reconfiguration message comprises the measurement configuration information.

17. The base station according to claim 15, wherein the measurement configuration information further comprises a measurement start indication, wherein the measurement start indication is used to indicate a time or a period for staring a measurement by the user equipment on the WiFi measurement object.
